(19) United States
(12) Patent Application Publication
(10) Pub. No.: US 2025/0371456 A1
(43) Pub. Date: Dec. 4, 2025

(54) SYSTEM AND METHOD FOR DISTRIBUTING WORKLOAD OF A WORKING-SHIFT OF A SOURCE-LOCATION TO WORKING-SHIFTS IN TARGET-LOCATIONS IN A MULTIPLE-LOCATIONS CONTACT CENTER

(71) Applicant: NICE LTD., Ra'anana (IL)

(72) Inventors: Vaibhav CHOBE, Pune (IN); Richa DEO, Jamshedpur (IN); Kanchan VASNANI, Indore (IN)

(21) Appl. No.: 18/732,677

(22) Filed: Jun. 4, 2024

(51) Int. Cl. G06Q 10/0631

(52) U.S. Cl. CPC G06Q 10/063112; G06Q 10/063116

(57) ABSTRACT

A computerized-method for distributing workload of a working-shift of a source-location to working-shifts in target-locations, via a WFM-application in a multiple-locations contact center. The computerized-method comprising: (i) receiving a rebalancing-request and workload-information of the working-shift of the source-location; (ii) parsing the workload-information to extract affected-SUs, target-SUs and critical-skills; (iii) for each parallel time-interval in a parallel working-shift of each target-location and for each critical-skill: retrieving staffing-plans of the target-SUs, and marking the parallel time-interval as overstaffed for the critical-skill based on a net-staffing calculation; (iv) operating agents-distribution for each parallel time-interval and for each critical-skill based on the parallel time-intervals marked as overstaffed; and (v) configuring WFM-application to: update staffing-plans of parallel working-shift of each target-location, based on the operated agents-distribution; generate new-schedules for agents in the target-SUs based on the updated staffing plans of parallel working-shift of each target-location; and remove existing schedules of the affected-SUs of parallel working-shift.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to the field of computerized systems and methods for distributing workload of a working-shift of a source-location to working-shifts in target-locations via an application, in a multiple-locations contact center.

### BACKGROUND

Each organization has a Business Continuity Plan (BCP) defined to ensure its business continues as planned, in case of any uncertain events which lead to infrastructural disruptions. Contact centers commonly work from multiple locations and have the work planned for its agents in the form of a schedule for a working-shift at a preconfigured time-interval, e.g., time-interval of 15 minutes. In case of any uncertain event, like a natural calamity or man-made events in one location, which cause disruption of the infrastructure or services, the workload from the location needs to be rebalanced with other locations, and hence it impacts the multiple locations of the contact center.

To rebalance to other locations, the contact center has to perform a number of steps like either manually adjust the workloads or re-generate the forecasts and schedules to balance the workload, which is a time-consuming activity and impacts the business operations when not handled in a timely manner.

Existing solutions require manual allocation via a Workforce Management (WFM) application of required skills along with the percentage distribution across different Scheduling Units (SU)s. The manual allocation involves a manual evaluation of the workload in the target SUs that it can handle. Once the workload of the target SUs has been evaluated, forecasts need to be regenerated and then schedules have to be regenerated to rebalance the requirements as specified in the BCP.

Therefore, there is a need for a technical solution to automatically balance volumes of contacts in a contact center for crucial skills. There is a need for a technical solution to automatically balance the load on the target SUs based on their current capacities, by creating realistic requirements and optimal schedules and automatically generate a staffing plan to be used as a reference for the source of requirements.

There is a need for a technical solution that will align with the organization's BCP and effectively rebalance workload of one location to other locations of the contact center by distributing the workload of a working-shift of a source-location to working-shifts in target-locations via a Workforce Management (WFM) application, in a multiple-locations contact center.

### SUMMARY

There is thus provided, in accordance with some embodiments of the present disclosure, a computerized-method for distributing workload of a working-shift of a source-location to working-shifts in target-locations via a Workforce Management (WFM) application, in a multiple-locations contact center.

In accordance with some embodiments of the present disclosure, the computerized-method may include: (i) receiving a rebalancing-request and workload-information of the working-shift of the source location, via a User Interface (UI) of the WFM application. The workload-information may include one or more source Scheduling Units (SU)s, one or more target SUs, and percentage-allocation for each critical-skill in one or more critical-skills; (ii) parsing the workload-information to extract one or more affected-SUs from the received one or more source SUs, one or more target SUs and the critical-skills; (iii) for each parallel time-interval in a parallel working-shift of each target-location in the target locations and for each critical-skill in the critical-skills: a. retrieving staffing plans of the one or more target SUs from a staffing-database that is associated to the WFM application; and b. marking the parallel time-interval as overstaffed for the critical-skill based on a net-staffing calculation; (iv) operating agents-distribution for each parallel time-interval in the parallel working-shift of each target-location and for each critical-skill in the critical-skills based on the parallel time-intervals marked as overstaffed; and (v) configuring the WFM application to: a. update staffing plans of parallel working-shift of each target-location in the target locations, based on the operated agents-distribution; b. generate new-schedules for agents in the one or more target SUs based on the updated staffing plans of parallel working-shift of each target-location in the target locations to be stored in an agents-schedules database; and c. remove existing schedules of the affected-SUs of parallel working-shift, from the agents-schedules database.

Furthermore, in accordance with some embodiments of the present disclosure, the parallel time-interval may be marked as overstaffed for the critical-skill based on net-staffing calculation when a number of agents having the critical-skill, that is required for the parallel time-interval is lower than a number of agents having the critical-skill, scheduled for the parallel time-interval.

Furthermore, in accordance with some embodiments of the present disclosure, the operating of the agents-distribution may be performed by distributing agents based on the percentage allocation of the critical-skill and agents having the critical-skill which are scheduled to the working-shift of the source-location, between one or more parallel time-intervals marked as overstaffed for the critical-skill, for each parallel time-interval in the parallel working-shift of each target-location and for each critical-skill in the critical-skills.

Furthermore, in accordance with some embodiments of the present disclosure, the computerized-method may further include: (i) receiving a period for work-shifts distribution of the source-location via the UI of the WFM application; (ii) operating distribution of workload of each working-shift in a plurality of working-shifts of the source-location to parallel working-shifts in the target-locations during the received period; and (iii) displaying via the UI of the WFM application a link to a file with details of each staffing plan of each working-shift of the source-location and related status as succeeded.

Furthermore, in accordance with some embodiments of the present disclosure, the computerized-method may be implemented in a cloud-based contact center application which is operated by a cloud computing service provider.

Furthermore, in accordance with some embodiments of the present disclosure, the computerized-method may be operated for one or more working-shifts in one or more source-locations.

There is further provided, in accordance with some embodiments of the present invention, a computerized-system for distributing workload of a working-shift of a source-location to working-shifts in target-locations via a Workforce Management (WFM) application, in a multiple-locations contact center.

Furthermore, in accordance with some embodiments of the present disclosure, the computerized-system includes one or more processors, a staffing-database that is associated to the WFM application, an agents-schedules database; and a memory to store the plurality of databases.

Furthermore, in accordance with some embodiments of the present disclosure, the one or more processors may be configured to: (i) receive a rebalancing-request and workload-information of the working-shift of the source location, via a User Interface (UI) of the WFM application. The workload-information may include a source Scheduling Unit (SU), one or more target SUs, and percentage-allocation for each critical-skill in one or more critical-skills; (ii) parse the received rebalancing-request to extract one or more affected-SUs from the received one or more target SUs and the critical-skills; (iii) for each parallel time-interval in a parallel working-shift of each target-location in the target locations and for each critical-skill in the critical-skills: a. retrieve staffing plans of the one or more target SUs from a staffing-database that is associated to the WFM application; b. mark the parallel time-interval as overstaffed for the critical-skill based on net-staffing calculation; (iv) operate agents-distribution for each parallel time-interval in the parallel working-shift of each target-location and for each critical-skill in the critical-skills based on the parallel time-intervals marked as overstaffed; and (v) configure the WFM application to: a. update staffing plans of parallel working-shift of each target-location in the target locations, based on the operated agents-distribution; b. generate new-schedules for agents in the one or more target SUs based on the updated staffing plans of parallel working-shift of each target-location in the target locations to be stored in an agents-schedules database; and c. remove existing schedules of the affected-SUs of parallel working-shift, from the agents-schedules database.

### BRIEF DESCRIPTION OF THE DRAWINGS

In order for the present invention, to be better understood and for its practical applications to be appreciated, the following Figures are provided and referenced hereafter. It should be noted that the Figures are given as examples only and in no way limit the scope of the invention. Like components are denoted by like reference numerals.

FIGS. 1A-1C schematically illustrate a high-level diagram of a computerized-system for distributing workload of a working-shift of a source-location to working-shifts in target-locations via a Workforce Management (WFM) application, in a multiple-locations contact center, in accordance with some embodiments of the present invention;

FIGS. 2A-2B schematically illustrates a high-level diagram of a computerized-method for distributing workload of a working-shift of a source-location to working-shifts in target-locations via a Workforce Management (WFM) application, in a multiple-locations contact center, in accordance with some embodiments of the present invention;

FIGS. 3A-3B schematically illustrate a high-level workflow of scheduler of rebalancing SUs, in accordance with some embodiments of the present invention; and

FIGS. 4A-4F show examples of User Interfaces (UI) s for distributing workload of a working-shift of a source-location to working-shifts in target-locations via a Workforce Management (WFM) application, in a multiple-locations contact center in accordance with some embodiments of the present invention.

### DETAILED DESCRIPTION

In the following detailed description, numerous specific details are set forth in order to provide a thorough understanding of the disclosure. However, it will be understood by those of ordinary skill in the art that the disclosure may be practiced without these specific details. In other instances, well-known methods, procedures, components, modules, units and/or circuits have not been described in detail so as not to obscure the disclosure.

Although embodiments of the disclosure are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes.

Although embodiments of the disclosure are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

Existing current solutions require the Workforce Manager (WFM) Manager to manually allocate the skills along with the percentage distribution across different Scheduling Units (SU)s by manually evaluating the workload that the target SUs can absorb. Once the workload has been evaluated, the forecasts are regenerated and then the corresponding schedules to rebalance the workload as per the requirements. This is overall a manual and a time-consuming process.

In a multiple-locations contact center, when one or more locations are shutdown abruptly, there is a need for a technical solution to automatically align organization's Business Continuity Plan (BCP) and to rebalance the workload of the one or more locations to other active locations.

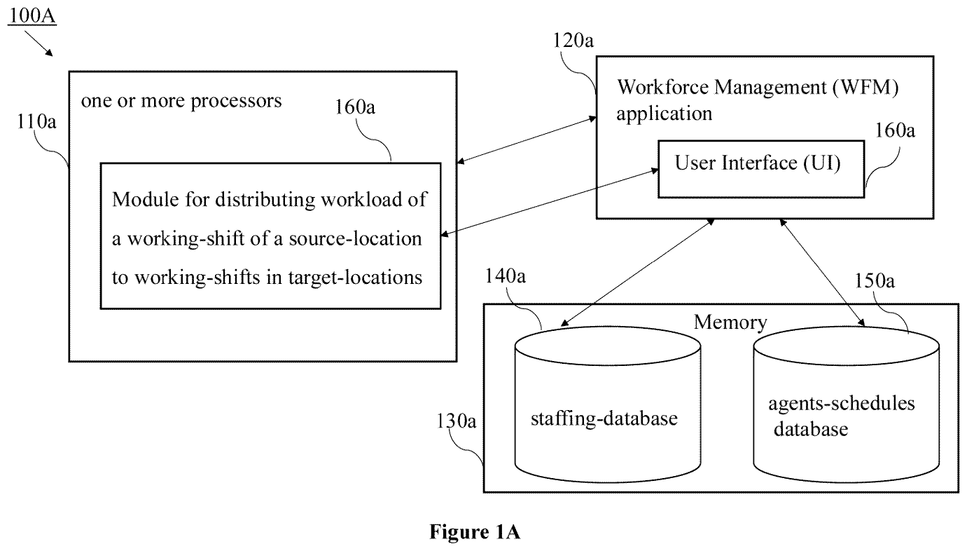

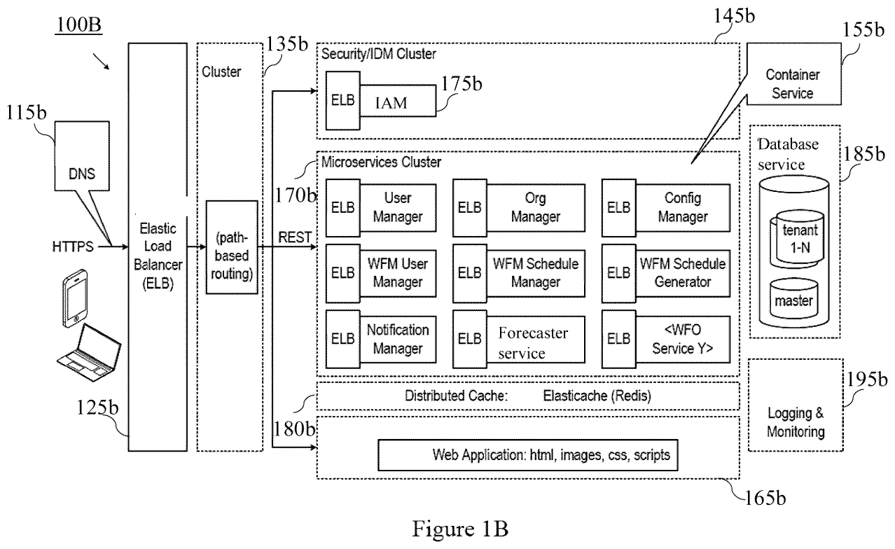

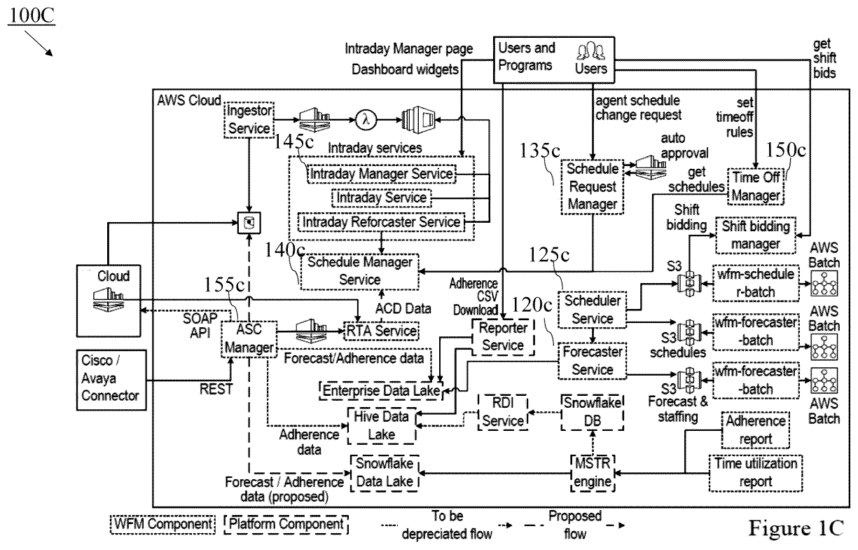

FIG. 1A schematically illustrates a high-level diagram of a computerized-system 100A for distributing workload of a working-shift of a source-location to working-shifts in target-locations via a Workforce Management (WFM) application, in a multiple-locations contact center, in accordance with some embodiments of the present invention.

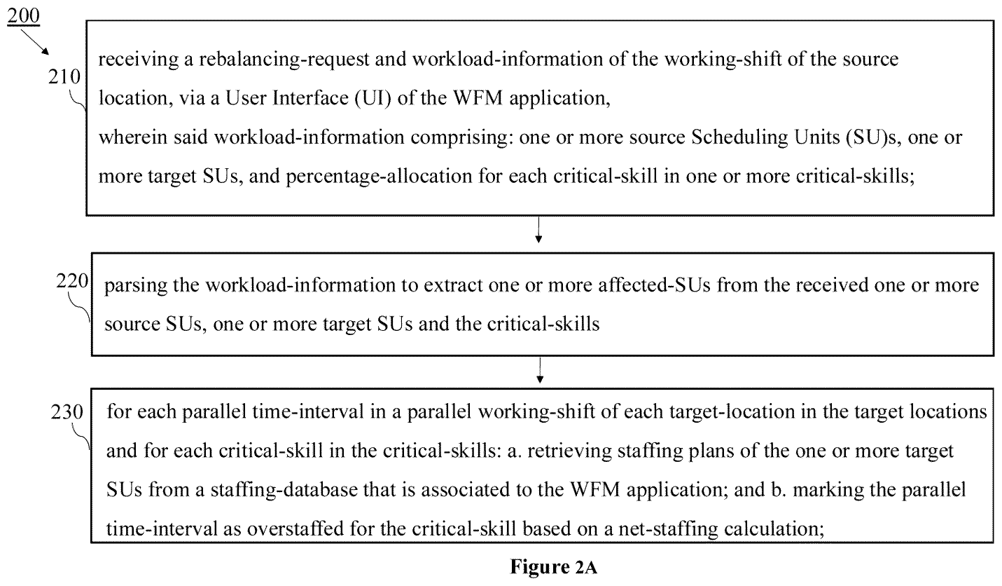

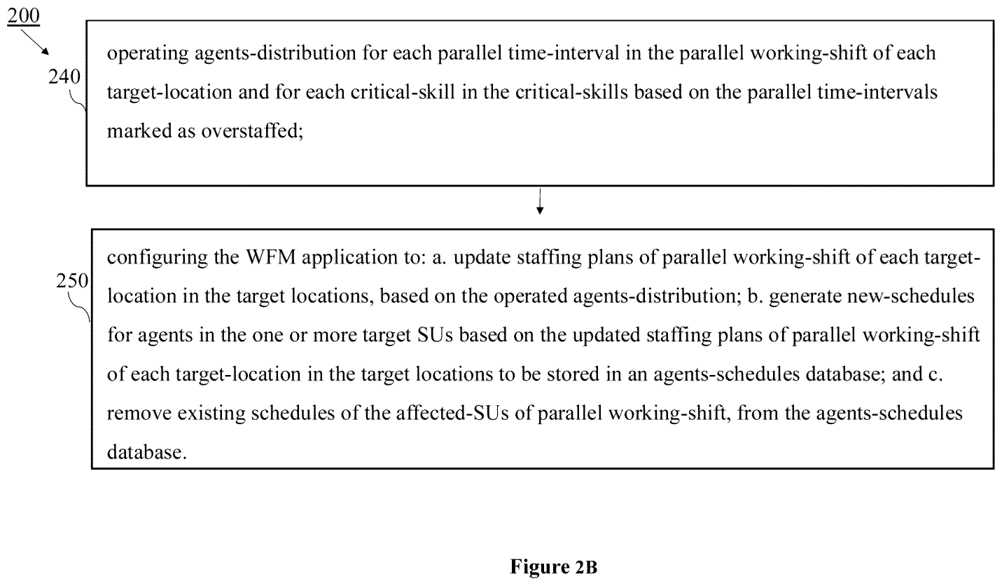

According to some embodiments of the present disclosure, a system, such as system 100A may implement a computerized-method for distributing workload of a working-shift of a source-location to working-shifts in target-locations via a Workforce Management (WFM) application, in a multiple-locations contact center, such as computerized method 200 in FIGS. 2A-2B by one or more processors 110a which are configured to operate a module, such as module for distributing workload of a working-shift of a source-location to working-shifts in target-locations 160a.

According to some embodiments of the present disclosure, a scheduling unit organizes employees into groups with common scheduling requirements, e.g., critical-skills. Scheduling units enable to handle forecasts, schedules, and adherence events for a group of workgroups as a single unit. The target locations are locations of the multiple locations contact center that remained active.

According to some embodiments of the present disclosure, system 100A may handle workload distribution of one or more source-locations to working-shifts in target-locations. The workload may include source Scheduling Units (SU)s, one or more target SUs, and percentage-allocation for each critical-skill in one or more critical-skills. The distribution of the workload may be operated for one or more source locations, which may have been suddenly shut down. also, the distribution of the workload may be of one or more working-shifts.

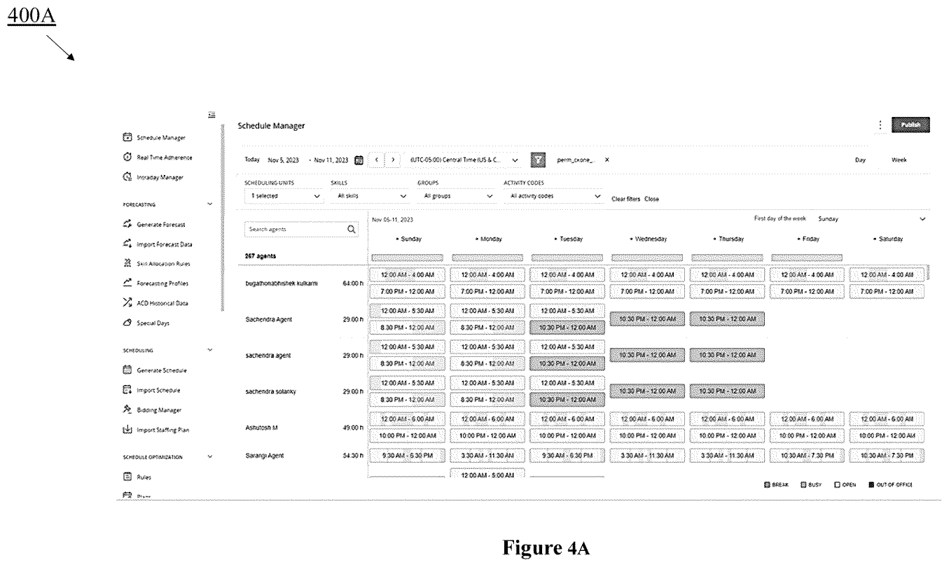

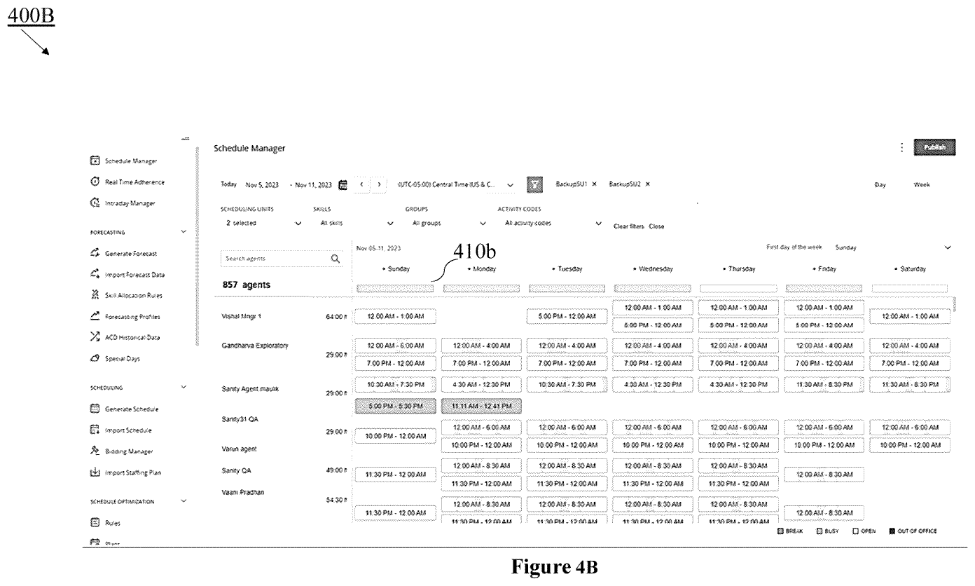

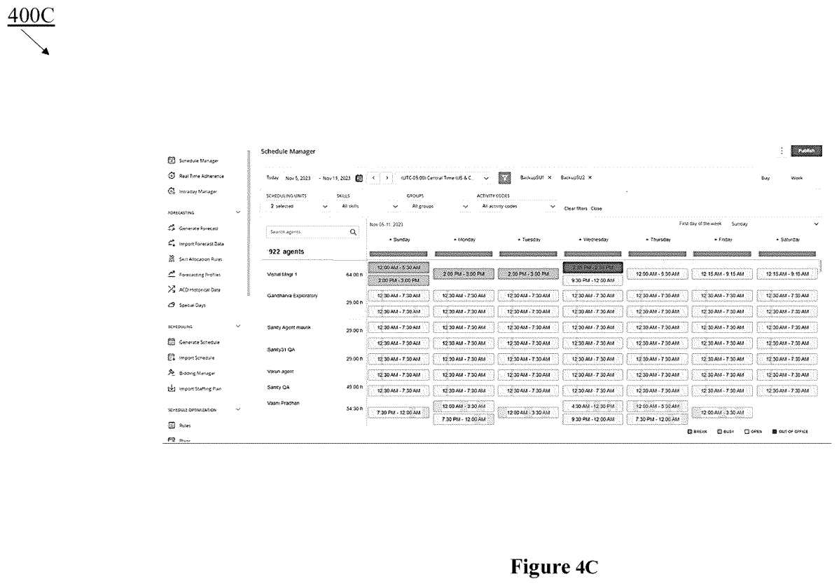

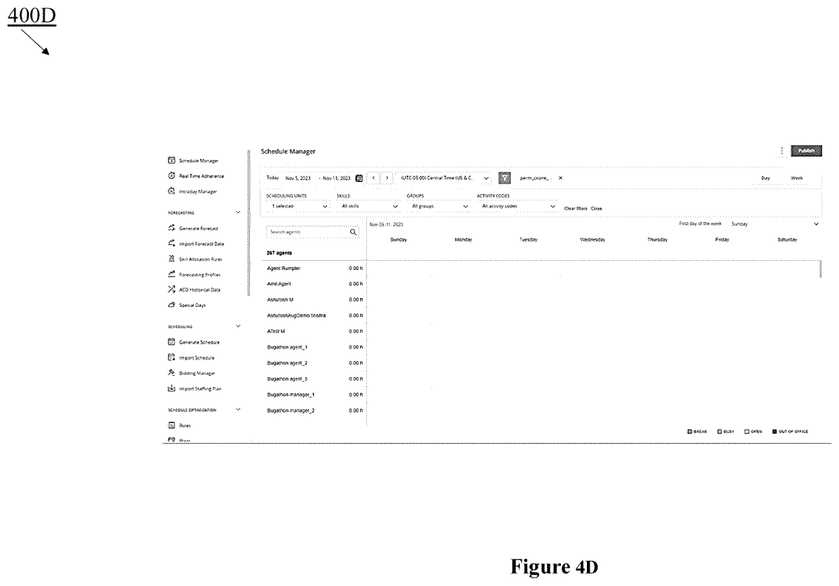

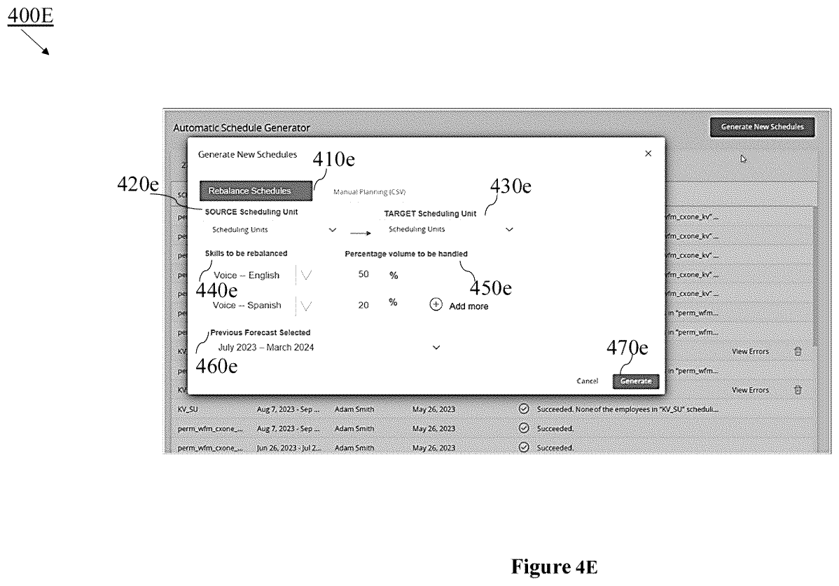

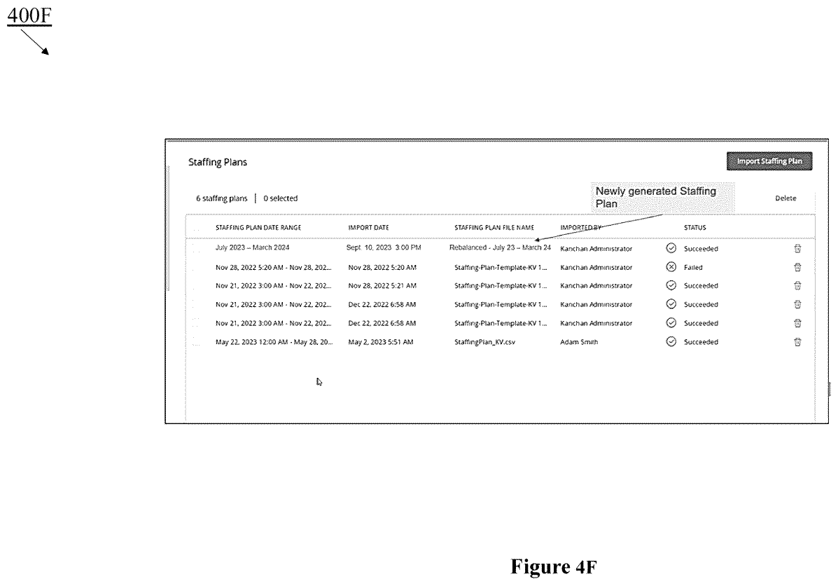

According to some embodiments of the present disclosure, system 100A may receive a rebalancing-request and workload-information of the working-shift of a source location, via a User Interface (UI) 160a of the WFM application 120a. For example, as shown in UI 400E in FIG. 4E.

According to some embodiments of the present disclosure, the workload-information may be parsed to extract affected-SUs from the received source SUs, target SUs and the critical-skills. For each parallel time-interval in a parallel working-shift of each target-location in the target locations and for each critical-skill in the critical-skills, retrieving staffing plans of the one or more target SUs from a staffing-database that is associated to the WFM application and marking the parallel time-interval as overstaffed for the critical-skill based on a net-staffing calculation. For example, as shown in UI 400A in FIG. 4A.

According to some embodiments of the present disclosure, the parallel time-interval may be marked as overstaffed for the critical-skill based on net-staffing calculation when a number of agents having the critical-skill, that is required for the parallel time-interval is lower than a number of agents having the critical-skill, scheduled for the parallel time-interval.

According to some embodiments of the present disclosure, agents-distribution may be operated for each parallel time-interval in the parallel working-shift of each target-location and for each critical-skill in the critical-skills based on the parallel time-intervals that were marked as overstaffed.

According to some embodiments of the present disclosure, the operating of the agents-distribution may be performed by distributing agents based on the percentage allocation of the critical-skill and agents having the critical-skill which are scheduled to the working-shift of the source-location, between one or more parallel time-intervals marked as overstaffed for the critical-skill, for each parallel time-interval in the parallel working-shift of each target-location and for each critical-skill in the critical-skills.

According to some embodiments of the present disclosure, the WFM application 120a may be configured to update staffing plans of parallel working-shift of each target-location in the target locations, based on the operated agents-distribution and then to generate new-schedules for agents in the one or more target SUs based on the updated staffing plans of parallel working-shift of each target-location in the target locations to be stored in a database, such as agents-schedules database 150a.

According to some embodiments of the present disclosure, existing schedules of the affected-SUs of parallel working-shift, may be removed from the agents-schedules database 150a.

According to some embodiments of the present disclosure, a period for work-shifts distribution of the source-location via the UI 160a of the WFM application 120a may be received and the operating of the distribution of workload of each working-shift in a plurality of working-shifts of the source-location to parallel working-shifts in the target-locations may be performed for the duration of the received period.

According to some embodiments of the present disclosure, a link to a file with details of each staffing plan of each working-shift of the source-location and related status as succeeded may be displayed via the UI 160a of the WFM application 120a. For example, as shown in UI 400F in FIG. 4F.

According to some embodiments of the present disclosure, the staffing-database 140a and the agents-schedules database 150a may be stored in memory 130a.

According to some embodiments of the present disclosure, system 100A may be implemented in a cloud-based contact center application which may be operated by a cloud computing service provider. For example, as shown in FIGS. 1B-IC.

According to some embodiments of the present disclosure, system 100A may balance the load on the target SUs based on the target SUs current capacities which may be automatically calculated, hence creating realistic requirements and optimal schedules. The staffing plan may be automatically generated for each target SU, and it may be used as a reference for the source of requirements, e.g., staffing requirement per skill per 15 minutes interval.

According to some embodiments of the present disclosure, system 100A may at the time of schedule generation, identify the critical skills and percentage of the volume to be handled by target-Scheduling Units (SU)s of the contact centers. Then, to assign the workload of the source SU, e.g., affected-SU in a location that has been abruptly shut down, system 100A may obtain the current staffing plan of each target-SU in the target SUs to identify their capacity to handle additional volumes.

According to some embodiments of the present disclosure, system 100A may generate the staffing plan for each targe-SU, such that the percentage volume is adjusted based on the ratio of the volume that can be handled by the target SUs. The staffing plan may be used as a source of the revised requirement.

According to some embodiments of the present disclosure, system 100A may automate rebalancing of workload when one or more locations in a multiple-location contact center is abruptly shut down by generating updated schedules in the target-SUs based on a revised staffing plan and removing the existing agent schedules of the source SU which is in the one or more locations that had a sudden shut down. Thus, reducing time and manual effort of distributing the schedule of the SU in each location that has been shut down and rebalancing the workload.

According to some embodiments of the present disclosure, redistribution of the workload from the source SU to target SUs may not be performed by human as to the complexity and the amount of data involved.

FIG. 1B schematically illustrates a high-level diagram of a computerized-system 100B for distributing workload of a working-shift of a source-location to working-shifts in target-locations via a Workforce Management (WFM) application, in a multiple-locations contact center, in accordance with some embodiments of the present invention.

According to some embodiments of the present disclosure, system 100A may be implemented in a cloud computing services infrastructure, such as Amazon® Web Services (AWS).

According to some embodiments of the present disclosure, Amazon Route 53 Resolver responds recursively to DNS queries from AWS resources for public records, Amazon VPC-specific DNS names, and Amazon Route 53 private hosted zones. Nginx is an open-source web server software that can also be used as a reverse proxy, load balancer, email proxy, and HTTP cache. It is a building block of WFM application architecture.

According to some embodiments of the present disclosure, a Simple Storage Service (Amazon S3 is a web-based cloud storage service offered by AWS. It's a scalable, high-speed service designed for online backup and archiving of data and applications. Amazon S3 stores data as objects within buckets. An object is a file and any metadata that describes the file. A bucket is a container for objects. It is a building block of WFM application architecture.

According to some embodiments of the present disclosure, Amazon CloudFront is a Content Delivery Network (CDN) service operated by AWS. It's designed to provide a globally-distributed network of proxy servers to cache content, such as web videos or other bulky media, more locally to consumers.

According to some embodiments of the present disclosure, Keycloak is an open-source Identity and Access Management (IAM) tool. It's designed to provide Single Sign-On (SSO) access to applications and services. Keycloak allows users to authenticate once and access multiple applications without needing to re-enter their credentials.

According to some embodiments of the present disclosure, Amazon Relational Database Service (RDS) is a web service offered by AWS. It is a managed Structured Query Language (SQL) database service that helps with relational database management tasks, such as data migration, backup, recovery, and patching.

According to some embodiments of the present disclosure, AWS CloudWatch is a monitoring and management service for AWS resources and applications. It collects and tracks metrics that measure your resources and applications. CloudWatch displays the metrics automatically about every chosen AWS service.

According to some embodiments of the present disclosure, Amazon Elastic Container Service (Amazon ECS) is a cloud computing service in AWS that manages containers. It allows developers to run applications in the cloud without having to configure an environment for the code to run in.

According to some embodiments of the present disclosure, EC2 stands for Elastic Compute Cloud. It's a web service that provides secure, resizable compute capacity in the cloud. EC2 is part of AWS. As part of ECS cluster mentioned above, there are the underlying EC2 instances where microservices gets deployed. It is a building block of WFM application architecture.

FIG. 1C schematically illustrates a high-level diagram of a computerized-system 100C for distributing workload of a working-shift of a source-location to working-shifts in target-locations via a Workforce Management (WFM) application, in a multiple-locations contact center, in accordance with some embodiments of the present invention.

According to some embodiments of the present disclosure, system 100A in FIG. 1a may be implemented in system 100C.

According to some embodiments of the present disclosure, a scheduler service in a WFM application, such as WFM application 120a in FIG. 1A may use a staffing plan that has been generated by forecaster service 120c and may generate the schedule for the selected Scheduling Unit (SU). The workload of a working-shift of a source-location may be distributed from the source SU to target SU for critical skills to working-shifts in target-locations via the WFM application, in a multiple-locations contact center. At the time of the schedule generation, the critical skills and percentage of the volume to be handled by the target SUs of the contact center may be identified by a user and may be entered via the UI of the WFM application.

According to some embodiments of the present disclosure, to assign the workload, the current staffing of the target SUs may be obtained to use their capacity to handle additional volumes by retrieving staffing plans of the target SUs from a staffing-database that is associated to the WFM application and marking the parallel time-interval as overstaffed for the critical-skill based on a net-staffing calculation.

According to some embodiments of the present disclosure, the staffing plan of the source SU and the information about the skill level staffing requirement, may be used as a reference in generating staffing plan for target SUs and target SUs, such that the percentage volume may be adjusted based on the ratio of the volume that can be handled by the target SUs. The staffing plan may be a source of the revised requirement. Updated schedules may be generated based on the revised staffing plan and existing agent schedules may be removed for agents in the source SU.

According to some embodiments of the present disclosure, a service, such as the forecaster service 120c may provide the forecast call volume and Average Handle Time (AHT) for future dates and generate a staffing plans based on historical data.

According to some embodiments of the present disclosure, the historical data, forecasting and staffing plan chart data may be provided via the UI of the WFM application, as well as create, edit and view of forecasting profiles. The WFM application may be configured to import the generated staffing plan.

According to some embodiments of the present disclosure, the schedule manager microservice 140c which is part of the WFM application, may be configured to store and retrieve schedule data, net staffing data, and all configurations required to generate schedules including daily rules, weekly rules, and activity codes.

According to some embodiments of the present disclosure, a micro-service, such as the Schedule Requests Manager (SRM) micro-service 135c may be part of the WFM application. The SRM micro-service 135c may manage all of the agent-generated Schedule Change Requests (SCR) s, such as adding, editing, getting, approving, and declining SCRs.

According to some embodiments of the present disclosure, upon new or edit of SCR submitting calls, the Schedule Rules Automation micro-service may validate API in order to validate the new or edited request against active auto approval rules. Submitting is disabled if there is a rule which auto decline the request.

According to some embodiments of the present disclosure, the SRM micro-service 135c may be called for saving the agent requests as new schedules, e.g., overwrites the schedule and then sends notifications to managers when requests are created. Notifications may be sent to agents on approval or decline. the data may be stored in RDS.

According to some embodiments of the present disclosure, the Real Time Adherence (RTA) agents states events may calculate the employees' adherence status by comparing the actual activity of the employee, received from the ACD with the expected activity scheduled for the employee that may be received from the schedule-manager micro-service. The agent's state may be in adherence or out of adherence.

According to some embodiments of the present disclosure, the intraday-manager micro-service 145c may be part of WFM applications. It may show all intraday metrics data e.g., actual, forecasted, variance per one skill or multiple skills for a preconfigured period, such as 24 hours' time-range. The forecasted data may be compared with actual data and a variance may be derived determine whether the contact center is understaffed or overstaffed.

According to some embodiments of the present disclosure, the intraday manager micro-service 145c may be part of WFM application and may handle the intraday data and metrics that are part of the dashboard. It may run each preconfigure period of time, e.g., every 15 minutes, and may be triggered by a scheduled task that runs automatically at specified intervals or specific times on a server, e.g., cron job. The intraday manager micro-service 145c may start two jobs: Get Forecast data, such as AHT, Average Speed of Answer (ASA), volume, SLA, staffing from schedule manager, e.g., netsaffing API and save it to a database.

According to some embodiments of the present disclosure, reforecast data may be calculated, e.g., AHT, ASA, Volume, SLA for all tenants with reforecast toggle On, and the results may be saved to ES. The forecast and reforecast data are presented by the intraday manager micro-service 145c.

According to some embodiments of the present disclosure, it may support receiving Intraday data from on-premise ACD, such as Cisco Unified Contact Center Express (UCCX) by monitoring a dedicated S3 bucket that the data is written to, normalize and resolve the received data and send it to the kinesis stream.

According to some embodiments of the present disclosure, the time-off-manager micro-service 150c may enable to define time-off rules via the UI of the WFM application, calculate time-off balance for agents and calculate API for automatic time off approval or semi-automatic approval.

FIGS. 2A-2B schematically illustrates a high-level diagram of a computerized-method for distributing workload of a working-shift of a source-location to working-shifts in target-locations via a Workforce Management (WFM) application, in a multiple-locations contact center, in accordance with some embodiments of the present invention.

According to some embodiments of the present disclosure, operation 210 comprising receiving a rebalancing-request and workload-information of the working-shift of the source location, via a User Interface (UI) of the WFM application. The workload-information comprising: one or more source Scheduling Units (SU)s, one or more target SUs, and percentage-allocation for each critical-skill in one or more critical-skills.

According to some embodiments of the present disclosure, operation 220 comprising parsing the workload-information to extract one or more affected-SUs from the received one or more source SUs, one or more target SUs and the critical-skills.

According to some embodiments of the present disclosure, operation 230 comprising for each parallel time-interval in a parallel working-shift of each target-location in the target locations and for each critical-skill in the critical-skills: a. retrieving staffing plans of the one or more target SUs from a staffing-database that is associated to the WFM application; and b. marking the parallel time-interval as overstaffed for the critical-skill based on a net-staffing calculation

According to some embodiments of the present disclosure, operation 240 comprising operating agents-distribution for each parallel time-interval in the parallel working-shift of each target-location and for each critical-skill in the critical-skills based on the parallel time-intervals marked as overstaffed.

According to some embodiments of the present disclosure, operation 250 comprising configuring the WFM application to: a. update staffing plans of parallel working-shift of each target-location in the target locations, based on the operated agents-distribution; b. generate new-schedules for agents in the one or more target SUs based on the updated staffing plans of parallel working-shift of each target-location in the target locations to be stored in an agents-schedules database; and c. remove existing schedules of the affected-SUs of parallel working-shift, from the agents-schedules database.

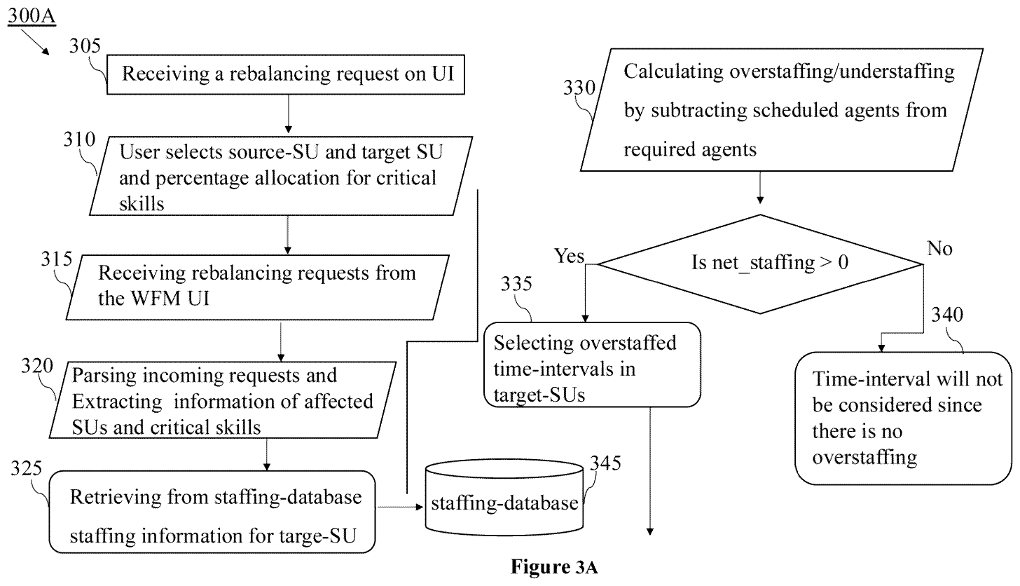

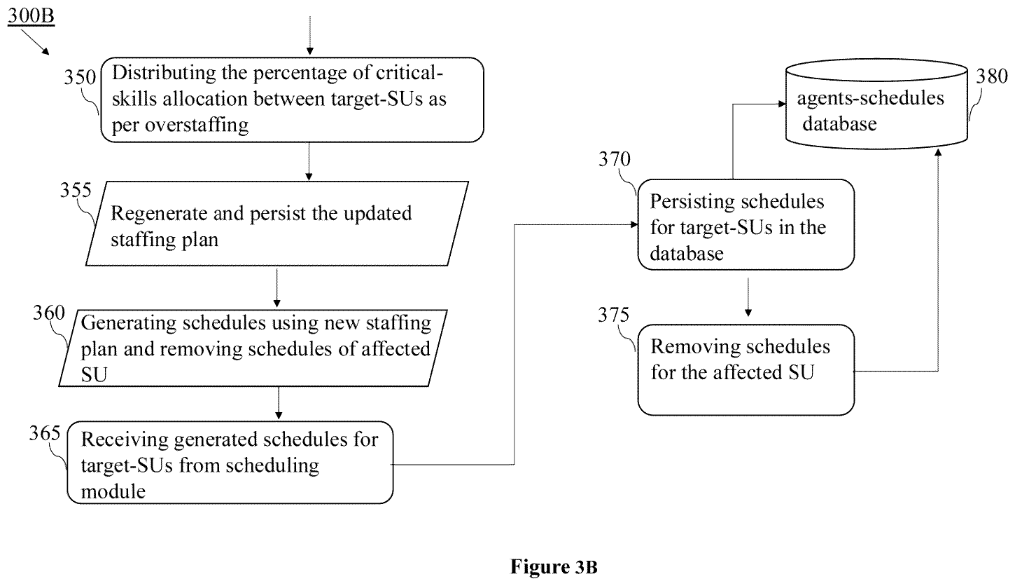

FIGS. 3A-3B schematically illustrate a high-level workflow of scheduler of rebalancing SUs, in accordance with some embodiments of the present invention.

According to some embodiments of the present disclosure, in a system, such as system 100A when a user, such as a supervisor initiating the rebalancing task, utilizing the WFM UI, such as UI 160a in FIG. 1A, the system may receive a rebalancing request on UI 305, which in turn triggers the Scheduler Service, such as scheduler service 125c in FIG. 1C.

According to some embodiments of the present disclosure, when the user selects source-SU and target SU and percentage allocation critical skills 310, information transmitted to the scheduler service may include the affected SU and target SUs. The primary objective of the supervisor is to uphold balanced staffing within the contact center. Receiving rebalancing requests from the WFM UI for example, by a user, such as a supervisor, which may select both the source and target SUs which are the target locations which are involved in the rebalancing procedure. Additionally, the percentage allocation for transferring critical skills from the source SU to the target SU(s) may be specified.

According to some embodiments of the present disclosure, identification and selection of critical skills may be based on the contact center's requirements. For example, if there are a total of 10 skills distributed among 5 SUs, e.g., SU1, SU2, . . . . SU5, and SU1 is affected, the supervisor evaluates which skills among the 10 are critical and require immediate attention. In this scenario, only those critical skills, such as skill1 and skill2, may be selected for prioritized handling.

According to some embodiments of the present disclosure, utilizing an API endpoint to receive rebalancing requests from the WFM UI. Parsing incoming requests and extracting information of affected SUs and critical skills 320 which triggers the scheduler service with relevant data.

According to some embodiments of the present disclosure, checking net staffing of target SU by retrieving from staffing-database staffing information for target SU 325. The staffing-database 345 may be a database such as staffing-database 140a in FIG. 1A. The system may assess the current staffing levels e.g., net staffing of the target SUs to gauge their ability to handle additional workload. Within the staffing-database 345, information regarding all staffing requirements per skill per scheduling unit, may be maintained, which may be integrated into the Scheduler service.

According to some embodiments of the present disclosure, net staffing assessment may be operated by accessing staffing-database 345 to retrieve staffing information for target SUs and then calculating overstaffing/understaffing by subtracting scheduled agents from required agents 330. The workload distribution may be determined for critical skills based on user-defined weightage.

According to some embodiments of the present disclosure, checking if net_staffing is larger than zero and when the net_staffing is larger than zero, i.e., there are time-intervals which are overstaffed, then selecting overstaffed time-intervals in the target-SUs 335. Otherwise, when a time-interval in the target-SU is not overstaffed, the time-interval will not be considered since there is no overstaffing 340.

According to some embodiments of the present disclosure, for example, when the impacted SU is SU1, and the critical skill is Skill1, where a required_agent count of 30 is identified. If SU2 and SU3 are chosen by the user as target SUs for rebalancing, the net staffing under these SUs will be evaluated.

According to some embodiments of the present disclosure, distributing the percentage of critical skills allocation between target-SUs as per overstaffing 350.

According to some embodiments of the present disclosure, for example, in SU2, if there are 10 required agents and 20 scheduled agents, then overstaffing_SU2 may be calculated as 20-14=+6, indicating that there are 6 additional agents available who can take on workload from the impacted SU. Similarly, in SU3, if there are 5 required agents and 15 scheduled agents, Overstaffing_SU3 would be calculated as 15−3=+12, indicating there are 12 additional agents available for workload assignment.

According to some embodiments of the present disclosure, considering a workload distribution for critical skills of 50%, based on user-defined critical skill weightage of the total required agents from SU1 e.g., 30 agents, we need to schedule 15 agents from the selected target SUs e.g., SU2 and SU3.

According to some embodiments of the present disclosure, the distribution allocation for SU2 may be calculated as su2_workload_distribution=(Workload_Distribution_For_Critical_Skills*Overstaffing_SU2)/(Overstaffing_SU2+Overstaffing_SU3)=(15*6)/(6+12)=5 agents.

According to some embodiments of the present disclosure, the distribution allocation for SU3 would be calculated as su3_workload_distribution=(Workload_Distribution_For_Critical_Skills*Overstaffing_SU3)/(Overstaffing_SU2+Overstaffing_SU3)=(15*12)/(6+12)=10 agents.

According to some embodiments of the present disclosure, this overload distribution strategy ensures workload distribution based on the percentage capacity overstaffing in the target SUs.

According to some embodiments of the present disclosure, after the redistribution, the staffing_data table in the staffing-database 345 may be revised, by checking the target SUs, e.g., SU2 and SU3. Since only critical skills are eligible for redistribution, the staffing plan for skill1 and skill2 may be updated accordingly.

According to some embodiments of the present disclosure, regenerate and persist the updated staffing plan 355.

According to some embodiments of the present disclosure, based on the calculation of workload, the distribution staffing data may be updated as follows, the staffing_data table in the staffing-database 345 by adjusting staffing plans for target SUs and critical skills. For SU2: su2_workload_distribution which is 5 agents as derived in the example, it may be updated for each interval of 15 minutes.

$$08 : 00 -> 5$$

$$08 : 15 -> 4$$

$$08 : 30 -> 0$$

$$08 : 45 -> 8.33$$

For SU3: su3_workload_distribution which is 10 agents as derived in the example, it may be updated for each interval of 15 minutes.

$$08 : 00 -> 10$$

$$08 : 15 -> 6$$

$$08 : 30 -> 2$$

$$08 : 45 -> 1.66$$

Inserts or updates records for the redistributed workload.

According to some embodiments of the present disclosure, the schedule generation may be operated by utilizing the staffing_data as its reference, the scheduler service will generate schedules accordingly. The updated staffing data may be received from the optimization module.

According to some embodiments of the present disclosure, generating schedules using new staffing plan and removing schedules of affected-SU 360. Then receiving generated schedules for target-SUs from scheduling module 365 and then persisting schedules for target-SUs in the database 370, such as agents-schedules database 380 and such as agents-schedules database 150a in FIG. 1A.

According to some embodiments of the present disclosure, the schedules may be saved by receiving the generated schedules from the scheduling module, then, saving the schedules for the target-SUs in the database, such as agents-schedules database 380 and then removing the schedules for the source SU from the database.

According to some embodiments of the present disclosure, the schedules may be updated and persisted to the database, such as agents-schedules database 380 for only agents of target SUs e.g., SU2 and SU3 and schedules of source SU e.g., SU1 may be removed.

According to some embodiments of the present disclosure, removing schedules for the affected SU 375.

FIG. 4A shows an example of a User Interfaces (UI) 400A of a source SU, for distributing workload of a working-shift of a source-location to working-shifts in target-locations via a Workforce Management (WFM) application, in a multiple-locations contact center in accordance with some embodiments of the present invention.

According to some embodiments of the present disclosure, UI 400A may display all the schedules assigned to agents in the affected SU in the location that has an abrupt shut down. UI 400A may provide a view of the current workload distribution and assignments within the impacted SU.

According to some embodiments of the present disclosure, each schedule entry may include details, such as agent name, shift timings, assigned tasks, and the like.

FIG. 4B shows an example of a UI 400B of a target SU, for distributing workload of a working-shift of a source-location to working-shifts in target-locations via a Workforce Management (WFM) application, in a multiple-locations contact center, in accordance with some embodiments of the present invention.

According to some embodiments of the present disclosure, UI 400B shows schedules assigned for a limited or lower number of employees in the target SU.

According to some embodiments of the present disclosure, UI 400B highlights the capacity constraints or underutilization of resources in the target SU compared to the affected SU in the source location. The UI 400B displays areas e.g., 410b where additional workload can be allocated because the contact center is overstaffed, to optimize resource utilization.

FIG. 4C shows an example of a UI 400C of target SU after rebalancing the workload, in accordance with some embodiments of the present invention.

According to some embodiments of the present disclosure, UI 400C displays the schedules generated for critical skills, including both existing schedules and newly allocated ones from the impacted SU. The updated workload distribution in the target SU may be displayed in UI 400C, incorporating the transferred schedules to address skill gaps or workload imbalances. the UI 400C may provide filters or indicators to distinguish between existing and newly generated schedules. UI 400C may show the schedules for both previous and distributed workloads. The UI 400C may show both old and new schedules of the target SU on the UI.

FIG. 4D shows an example of a UI 400D of affected SU after the rebalancing of the workload, in accordance with some embodiments of the present invention.

According to some embodiments of the present disclosure, schedules previously assigned to the impacted SU, e.g., affected SU are removed from the database, such as agents-schedules database 150a in FIG. 1A. UI 400D may show that no schedules are present in the impacted SU, indicating the successful transfer of workload to the target SUs. The UI 400D may include notifications or logs to confirm the completion of the rebalancing process and the removal of schedules from the impacted SU, e.g., affected SU in the location that had a sudden shut down in the multiple-locations contact center.

FIG. 4E shows an example of a UI 400E for distributing workload of a working-shift of a source-location to working-shifts in target-locations via a Workforce Management (WFM) application, in a multiple-locations contact center in accordance with some embodiments of the present invention.

According to some embodiments of the present disclosure, the schedules or rebalance API may initiate the rebalancing process by accepting parameters, such as critical skills, their corresponding percentages, and the impacted source SU along with one or more target SUs.

According to some embodiments of the present disclosure, instead of manually rebalancing schedules of source SU to target SUs, upon user click on rebalancing schedules 410a tab, the following icons 420e-470e may be displayed to provide a rebalancing-request and workload-information of the working-shift of the source location.

According to some embodiments of the present disclosure, UI 400E may be associated to the WFM application which operates the schedule generation rebalancing from the source SU to the target SU. Via the UI 400E the source SU may be selected from which the schedules will be rebalanced. For example, the selection of the source SU menu be operated upon user click on the source SU, in the source scheduling unit section 420e, a dropdown menu or list of available SUs may be displayed for selection. Upon the selection of source SU, relevant information about the source SU, such as current staffing levels, scheduled activities, and skill distributions, may be displayed for reference.

According to some embodiments of the present disclosure, via the UI 400E, the target SUs may be selected. Similar to the source SU selection, this section 430w may enable the user to choose the target SU where the rebalanced schedules may be allocated. The UI 400E may provide options for selecting multiple target SUs, allowing for flexible distribution of workload across different locations of the contact center.

According to some embodiments of the present disclosure, in skills to be rebalanced section 440c in the UI 400E, upon user click the skills that need to be rebalanced from the source SU to the target SU may be specified. Each skill may be listed along with the percentage volume of workload to be transferred. The UI 400E may also include checkboxes, dropdown menus, or input fields for the user to indicate the desired skill types and their corresponding allocation percentages.

According to some embodiments of the present disclosure, in percentage volume to be handled 450c, the percentage-allocation for each critical-skill in one or more critical-skills may be configured.

According to some embodiments of the present disclosure, in previous forecast selection section 460e, upon user click, previous forecast or historical data set to inform the rebalancing process may be selected. The UI 400E may present a calendar or date picker for selecting the relevant time frame for the forecast data. Users can review past performance metrics, staffing trends, and workload patterns to make informed decisions about schedule rebalancing.

According to some embodiments of the present disclosure, user click on the generate button 470c in UI 400E may trigger initiation of the schedule generation and rebalancing process. Upon clicking the button, a system, such as system 100A may process user inputs e.g., input in other sections in the UI 400E and may reallocate or distribute schedules based on the specified criteria and generates updated schedules for the target SU(s). The UI 400E may display a confirmation message or progress indicator to inform the user that the rebalancing is in progress.

FIG. 4F shows an example of a UI 400F for the generated staffing plan, in accordance with some embodiments of the present invention.

According to some embodiments of the present disclosure, UI 400F may display a grid-based layout to display the relevant information clearly. The top item on the grid shows that we have generated staffing plan automatically in scheduler micro-service which may have source SU load rebalanced to target SU.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments; thus, certain embodiments may be combinations of features of multiple embodiments. The foregoing description of the embodiments of the disclosure has been presented for the purposes of illustration and description. It is not intended to be exhaustive or to limit the disclosure to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the disclosure.

While certain features of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the disclosure.

What is claimed:

1. A computerized-method for distributing workload of a working-shift of a source-location to working-shifts in target-locations via a Workforce Management (WFM) application, in a multiple-locations contact center, said computerized-method comprising:
(i) receiving a rebalancing-request and workload-information of the working-shift of the source location, via a User Interface (UI) of the WFM application,
wherein said workload-information comprising: one or more source Scheduling Units (SU)s, one or more target SUs, and percentage-allocation for each critical-skill in one or more critical-skills,
(ii) parsing the workload-information to extract one or more affected-SUs from the received one or more source SUs, one or more target SUs and the critical-skills;
(iii) for each parallel time-interval in a parallel working-shift of each target-location in the target locations and for each critical-skill in the critical-skills:
a. retrieving staffing plans of the one or more target SUs from a staffing-database that is associated to the WFM application; and
b. marking the parallel time-interval as overstaffed for the critical-skill based on a net-staffing calculation;
(iv) operating agents-distribution for each parallel time-interval in the parallel working-shift of each target-location and for each critical-skill in the critical-skills based on the parallel time-intervals marked as overstaffed; and
(v) configuring the WFM application to:
a. update staffing plans of parallel working-shift of each target-location in the target locations, based on the operated agents-distribution;
b. generate new-schedules for agents in the one or more target SUs based on the updated staffing plans of parallel working-shift of each target-location in the target locations to be stored in an agents-schedules database; and
c. remove existing schedules of the affected-SUs of parallel working-shift, from the agents-schedules database.

2. The computerized-method of claim 1, wherein the parallel time-interval is marked as overstaffed for the critical-skill based on net-staffing calculation when a number of agents having the critical-skill, that is required for the parallel time-interval is lower than a number of agents having the critical-skill, scheduled for the parallel time-interval.

3. The computerized-method of claim 1, wherein the operating of the agents-distribution is performed by distributing agents based on the percentage allocation of the critical-skill and agents having the critical-skill which are scheduled to the working-shift of the source-location, between one or more parallel time-intervals marked as overstaffed for the critical-skill, for each parallel time-interval in the parallel working-shift of each target-location and for each critical-skill in the critical-skills.

4. The computerized-method of claim 1, wherein said computerized-method is further comprising:
(i) receiving a period for work-shifts distribution of the source-location via the UI of the WFM application;
(ii) operating distribution of workload of each working-shift in a plurality of working-shifts of the source-location to parallel working-shifts in the target-locations during the received period; and
(iii) displaying via the UI of the WFM application a link to a file with details of each staffing plan of each working-shift of the source-location and related status as succeeded.

5. The computerized-method of claim 1, wherein said computerized-method is implemented in a cloud-based contact center application which is operated by a cloud computing service provider.

6. A computerized-system for distributing workload of a working-shift of a source-location to working-shifts in target-locations via a Workforce Management (WFM) application, in a multiple-locations contact center, said computerized-system comprising:
one or more processors;
a staffing-database that is associated to the WFM application;
an agents-schedules database; and
a memory to store the plurality of databases,
said one or more processors are configured to:
(i) receive a rebalancing-request and workload-information of the working-shift of the source location, via a User Interface (UI) of the WFM application,
wherein said workload-information comprising: a source Scheduling Unit (SU), one or more target SUs, and percentage-allocation for each critical-skill in one or more critical-skills,
(ii) parse the received rebalancing-request to extract one or more affected-SUs from the received one or more target SUs and the critical-skills;
(iii) for each parallel time-interval in a parallel working-shift of each target-location in the target locations and for each critical-skill in the critical-skills:
a. retrieve staffing plans of the one or more target SUs from a staffing-database that is associated to the WFM application;
b. mark the parallel time-interval as overstaffed for the critical-skill based on net-staffing calculation;
(iv) operate agents-distribution for each parallel time-interval in the parallel working-shift of each target-location and for each critical-skill in the critical-skills based on the parallel time-intervals marked as overstaffed; and
(v) configure the WFM application to:
a. update staffing plans of parallel working-shift of each target-location in the target locations, based on the operated agents-distribution;
b. generate new-schedules for agents in the one or more target SUs based on the updated staffing plans of parallel working-shift of each target-location in the target locations to be stored in an agents-schedules database; and
c. remove existing schedules of the affected-SUs of parallel working-shift, from the agents-schedules database.
